(19) United States
(12) Patent Application Publication
(10) Pub. No.: US 2024/0055683 A1
(43) Pub. Date: Feb. 15, 2024

(54) RECOVERY OF METALS

(71) Applicant: Renewable Metals Company Pty Ltd, Belmont, Perth (AU)

(72) Inventors: Mark Daniel Urbani, Wattle Grove (AU); Gary Donald Johnson, Subiaco (AU); Nicholas John Vines, High Wycombe (AU)

(21) Appl. No.: 18/264,845

(22) PCT Filed: Feb. 11, 2022
(86) PCT No.: PCT/AU2022/050092

§ 371 Date: Aug. 9, 2023

(30) Foreign Application Priority Data
Feb. 12, 2021 (AU) 2021900358

(51) Int. Cl. H01M 10/54; C22B 15/00; C22B 3/00; C22B 26/12

(52) U.S. Cl. CPC H01M 10/54; C22B 15/0078; C22B 23/0446; C22B 26/12; C22B 23/0461

(57) ABSTRACT

A method for the recovery of metals from a feed stream (1) containing one or more value metals, the method comprising: (i) passing the feed stream (1) to an alkaline leach (20) to form a slurry (5) including a pregnant leach liquor of soluble metal salts and a solid residue; (ii) separating the pregnant leach liquor (8) and the solid residue (7) of step (i); (iii) passing the separated pregnant leach liquor (8) of step (ii) to a solvent extraction step (42), wherein a loaded extractant (9) containing copper and nickel, and a raffinate (19) containing cobalt and lithium, are produced; (iv) recovering cobalt (24) from the raffinate (19) of step (iii); and (v) recovering lithium (38), ammonia (28) and ammonium chloride (39) from the cobalt depleted liquor (21) of step (iv).

### TECHNICAL FIELD

The present invention relates to a method for the recovery of metals. More particularly, the method of the present invention relates to the recovery of metals from feed materials containing such metals.

In one embodiment, the present invention relates to a method for the recovery of metals from spent lithium-based (Li-ion) batteries.

### BACKGROUND ART

The volume of rechargeable Li-ion batteries used worldwide has been growing rapidly in recent years and is set for further expansion with the emerging markets of electric vehicles and mass electric power storage. As the demand for Li-ion batteries increases, so does the demand for the metal/metal oxide components that are used in these batteries. The rapid increase in demand for some of these metals, such as cobalt, has put pressure on the sustainable supply of such resources. This has caused the cost of such metals to rapidly increase.

There has been little interest in developing processes for the recovery and recycling of the various components in modern batteries. This is mainly due to the relatively low volume of Li-ion batteries available for recycling and the relatively high cost of the typical pyrometallurgical and hydrometallurgical processes by which the recovery is achieved. As the demand for Li-ion batteries continues to increase, so too does the volume of spent Li-ion batteries that are available for recycling. There is a need for low-cost, efficient recycling processes, particularly in respect of the more complex metal/metal oxide components.

The composition of Li-ion batteries has evolved considerably over recent times. Whilst some battery recycling processes have been developed, these have primarily been limited to the recovery of certain specific metals from a certain specific type of battery or feed source. For example, early batteries were predominantly lithium-cobalt and the focus of the recovery methods was on recovering cobalt. As lithium demand increased, the recovery methods shifted to the recovery of both cobalt and lithium. As battery technologies underwent further developments, the cathodes incorporated other metals, such as manganese, nickel, aluminium, iron and phosphorus. The methods used to recover lithium and cobalt are not suited for the recovery of other metals, nor are they well suited for different battery chemistries.

The uptake in the usage of Li-ion batteries will increase the volume of spent Li-ion batteries available for recycling. However, the supply of spent Li-ion batteries will include many different types of batteries. The suitability of recovery methods to only a single battery type presents a significant problem to the commercialisation of such processes. Specifically, such methods will require one or more sorting steps. There is a need for the development of a process for the recovery of a range of metals from a range of different Li-ion battery types.

Most developments in battery recycling processing involve dissolution of the metal components in acidic media. This is a non-selective leaching process during which most metals contained in a battery are dissolved. Batteries contain non-valuable metals, such as iron, manganese and aluminum, at an appreciable amount. Acid consumption is high if these non-valuable metals are not rejected prior to leaching. Consequently, pretreatment processes are required to separate iron and aluminum from the valuable metal components cobalt, nickel, copper and lithium. In so doing, the recovery of these valuable metals diminishes as the separations achieved in these pretreatment processes are not 100% efficient.

The method of the present invention has as one object thereof to overcome substantially one or more of the abovementioned problems associates with the prior art, or to at least provide a useful alternative thereto.

The preceding discussion of the background art is intended to facilitate an understanding of the present invention only. The discussion is not an acknowledgement or admission that any of the material referred to is or was part of the common general knowledge, in Australia or elsewhere, as at the priority date of the application.

Throughout this specification, unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

In accordance with the present invention there is provided a method for the recovery of metals from a feed stream containing one or more value metals, the method comprising:
(i) passing the feed stream to an alkaline leach to form a slurry including a pregnant leach liquor of soluble metal salts and a solid residue;
(ii) separating the pregnant leach liquor and the solid residue of step (i);
(iii) passing the separated pregnant leach liquor of step (ii) to a solvent extraction step, wherein a loaded extractant containing copper and nickel, and a raffinate containing cobalt and lithium, are produced;
(iv) recovering cobalt from the raffinate of step (iii); and
(v) recovering lithium, ammonia and ammonium chloride from the cobalt depleted liquor of step (iv).

In preferred forms of the present invention, the feed stream comprises one or more of copper, iron, manganese, aluminium, cobalt, nickel and lithium.

Preferably, the alkaline leach is:
a) Conducted at elevated temperature;
b) Conducted at atmospheric pressure;
c) An oxidative leach; and/or
d) Conducted in one or more leach reactors.

The alkaline leach is preferably a leach in ammonia/ammonium chloride.

Preferably, the leach is conducted at atmospheric pressure and at a temperature of:
(i) up to about 60° C.; or
(ii) about 40° C.

Preferably, the concentration of ammonia and ammonium chloride present in the leach is:
(i) up to saturation;
(ii) greater than about 5 g/L NH₄Cl and between about 10 g/L and 280 g/L NH₃; or
(iii) greater than about 5 g/L NH₄Cl and greater than about 100 g/L NH₃.

The residence time of the feed stream in the leach is preferably in the range of:
(i) about 1 to 4 hours; or
(ii) about 1 to 2 hours.

In one embodiment of the present invention, the method further comprises a pre-treatment process prior to step (i).

Preferably, the pre-treatment process comprises one or more mechanical treatment steps. The mechanical treatment step or steps preferably comprise one or more size reduction steps, for example one or more of a crushing step and a shredding step.

In one form of the present invention the one or more size reduction steps further comprise a granulation and/or a grinding step.

Preferably, the pre-treatment processes produce a feed stream for step (i) that is P100 about 5 mm. Still preferably, the feed stream for step (i) is P100 about 1 mm.

Preferably, the feed stream comprises Li-ion batteries.

Still preferably, a significant proportion of any contained cobalt, nickel, copper and lithium in the Li-ion batteries is solubilised to the leach liquor of the leach slurry and a significant proportion of any contained iron, manganese and aluminium in the Li-ion batteries report to the solid fraction of the leach slurry.

The significant proportion of the contained cobalt, nickel, copper and lithium that is solubilised is preferably greater than about 90% nickel, copper and cobalt, and greater than about 70% lithium.

The significant proportion of the contained iron, manganese and aluminium contained in the battery that reports to the solid fraction of the leach slurry is preferably greater than about 99% of aluminium and iron, and greater than about 95% of manganese.

In one form of the present invention the pre-treatment step or steps are undertaken without prior removal of plastic and aluminium casing materials.

Preferably, the alkaline leach is undertaken in a leach circuit comprising a leach section, a thickener section and a filter section.

In one form of the present invention the anion present is a mixed chloride/sulfate.

The oxidant can be any suitable oxidant, although preferably chosen from the group of air, hydrogen peroxide, hypochlorite and the like. Preferably, air is used as an oxidant.

Preferably, iron, aluminium and manganese are not extracted in significant amounts and therefore the leach is selective for nickel, cobalt, copper and lithium.

In one form of the present invention, the solvent extraction step comprises the contact of the pregnant leach liquor with an extractant to extract one or more metals to produce a loaded extractant containing the one or more extracted metals. Preferably, the solvent extraction step further comprises the separation of the loaded extractant from the pregnant leach liquor. More preferably, the solvent extraction step further comprises the recovery of the metal from the loaded extractant.

In one form of the present invention, the solvent extraction step is adapted to recover copper and nickel from the pregnant leach liquor. Preferably, the pregnant leach liquor is contacted with a copper/nickel extractant to produce a copper and nickel depleted pregnant leach liquor or raffinate, and loaded copper extractant. More preferably, copper and nickel are recovered from the loaded copper extractant by stripping with sulfuric acid. Nickel is selectively stripped with a lower residual acid concentration, preferably in the pH range of about 1-4, and copper is stripped with a higher acid concentration, preferably greater than about 50 g/L H₂SO₄. This two-stage stripping enables copper and nickel to be separated. Still preferably, copper and nickel are recovered as sulfates.

In one form of the present invention a portion of the copper and nickel depleted solvent extraction raffinate is recycled to the alkaline leach to extract more metal therefrom. Preferably, the copper and nickel depleted raffinate contains lithium, cobalt, ammonium chloride and ammonia.

In one form of the present invention cobalt is precipitated from the copper and nickel depleted raffinate as a sulfide. This is conducted by the addition of a sulfide containing precipitation reagent, for example hydrogen sulfide gas or ammonium sulfide, to force the precipitation of relatively insoluble cobalt sulfide. The resultant slurry is preferably subjected to a solid liquid separation stage to produce a cobalt product and a filtrate containing lithium, ammonium chloride and ammonia.

In one form of the present invention, a portion of the cobalt depleted filtrate, containing ammonium chloride and ammonia, is recycled to the alkaline leach to extract more metal.

In one form of the present invention, cobalt is precipitated from the nickel and copper depleted raffinate as a carbonate. This is conducted, for example, by the stochiometric addition of carbon dioxide and steam stripping of excess ammonia to force the crystallisation of cobalt carbonate. The resultant slurry is subjected to a solid liquid separation stage to produce a cobalt product and a filtrate containing lithium and ammonium chloride and ammonia.

In one form of the present invention, part of the cobalt depleted filtrate, which contains ammonium chloride and the recovered ammonia from the steam strip is recycled to the leach stage to extract more metal.

In one form of the present invention, part of the cobalt depleted filtrate, which comprises lithium, ammonia and ammonium chloride is treated to recover the components for recycle and or sale. Ammonia is initially steam stripped and recovered ammonia is directed to the leach to recover more metal. The ammonium chloride, present in the ammonia free liquor, is crystallised by forced evaporation, and subjected to solid liquor separation to produce a solid containing ammonium chloride and liquor containing concentrated lithium chloride. The solids are directed to the leach to recover more metal. The concentrated liquor is subjected to lithium recovery.

In one form of the present invention, the recovery of lithium from the concentrated liquor more specifically comprises the precipitation of a lithium compound. Preferably, the lithium compound is subsequently recovered from the liquor. In one embodiment, the lithium compound is lithium carbonate. Preferably, the concentrated liquor is contacted with ammonium carbonate or ammonia and carbon dioxide to precipitate lithium carbonate. The precipitation slurry is subjected to solid liquor separation to produce a solid containing lithium carbonate and liquor containing ammonium chloride, which is directed to the leach to recover more metal.

### BRIEF DESCRIPTION OF THE DRAWINGS

The present invention will now be described, by way of example only, with reference to the accompanying drawings in which:

FIG. 1 is a flow sheet depicting the method for the recovery of metals in accordance with the present invention;

FIG. 2 is a graphical representation of the levels of extraction of various metals achieved in the alkaline leach of the method of FIG. 1 over time;

FIG. 3 is a copper solvent extraction isotherm demonstrating the relationship between aqueous and organic copper levels in the solvent extraction step of the method of FIG. 1; and

FIG. 4 is a nickel solvent extraction isotherm demonstrating the relationship between aqueous and organic nickel levels in the solvent extraction step of the method of FIG. 1.

### BEST MODE(S) FOR CARRYING OUT THE INVENTION

The present invention provides a method for the recovery of metals from a feed stream containing one or more value metals, the method comprising:
(i) passing the feed stream to an alkaline leach to form a slurry including a pregnant leach liquor of soluble metal salts and a solid residue;
(ii) separating the pregnant leach liquor and the solid residue of step (i);
(iii) passing the pregnant leach liquor of step (ii) to a solvent extraction step, wherein a loaded extractant containing copper and nickel, and a raffinate containing cobalt and lithium, are produced;
(iv) recovering cobalt from the raffinate of step (iii); and
(v) recovering lithium, ammonia and ammonium chloride from the cobalt depleted liquor of step (iv).

The feed stream comprises one or more of copper, iron, manganese, aluminium, cobalt, nickel and lithium.

The alkaline leach is:
a) Conducted at elevated temperature;
b) Conducted at atmospheric pressure;
c) An oxidative leach; and/or
d) Conducted in one or more leach reactors.

The alkaline leach is a leach in an ammonium salt or ammonia, in the presence of chloride ions.

The leach is conducted at atmospheric pressure and at a temperature of:
(i) up to about 60° C.; or
(ii) about 40° C.

The concentration of ammonia and ammonium chloride present in the leach is:
(i) up to saturation;
(ii) greater than about 5 g/L NH₄Cl and between about 10 g/L and 280 g/L NH₃; or
(iii) greater than about 5 g/L NH₄Cl and greater than about 100 g/L NH₃.

The residence time of the feed stream 2 in the leach is in the range of:
(i) about 1 to 4 hours; or
(ii) about 1 to 2 hours.

The method of the present invention is understood to be particularly useful for the recovery of at least a significant portion of all the value metals from spent Li-ion batteries, preferably as high purity sulphates. The process is particularly robust in that it can accommodate a variety of Li-ion battery chemistries as a single or mixed feed source. The leaching process is selective in that a significant proportion of the contained cobalt, nickel, copper and lithium in the battery is solubilised to the leach liquor of the leach slurry and a significant proportion of the contained iron, manganese and aluminium contained in the battery report to the solid fraction of the leach slurry.

The significant proportion of the contained cobalt, nickel, copper and lithium that is solubilised is, for example, greater than about 90% nickel, copper and cobalt, and greater than about 70% lithium.

The significant proportion of the contained iron, manganese and aluminium contained in the battery that reports to the solid fraction of the leach slurry is, for example, greater than about 99% of aluminium and iron, and greater than about 95% of manganese.

This is achieved by way of an oxidative alkaline leach using ammonia, ammonium ions and air, in the presence of chloride ions, at atmospheric pressures. This is followed by stage wise sequential metal recovery using solvent extraction and precipitation techniques. This has been found by the Applicant to be particularly advantageous as there is little sorting of different battery types required.

In preferred forms of the present invention, the feed stream comprises one or more of copper, iron, manganese, aluminium, cobalt, nickel and lithium.

In one embodiment, the method further comprises a pre-treatment process prior to step (i).

The pre-treatment process comprises one or more mechanical treatment steps. For example, the mechanical treatment steps comprise one or more of a crushing step and a shredding step.

The pre-treatment process comprises one or more size reduction steps. For example, the one or more size reduction steps comprise a granulation and/or a grinding step.

The leach circuit comprises a leach section, a thickener section and a filter section.

In one form of the present invention, the step of subjecting the feed stream to an alkaline leach to form a slurry including a pregnant leach liquor of soluble metal salts and a solid residue, more specifically comprises subjecting the feed stream to an ammonium chloride/ammonia leach in one or more leach reactors.

The step of subjecting the feed stream to an ammonium chloride/ammonia leach is conducted at atmospheric pressure.

The step of subjecting the feed stream to an ammonium chloride/ammonia leach is conducted at elevated temperature.

In one form of the present invention the anion present is a mixed chloride/sulfate.

Any suitable oxidant is used in the leach, such as air, hydrogen peroxide, hypochlorite and the like. However, air is preferred for its availability and low cost.

Iron, aluminium and manganese are not extracted to significant amounts and therefore the leach is selective for nickel, cobalt, copper and lithium.

In one form of the present invention, a solvent extraction step comprises the contact of the pregnant leach liquor with an extractant to extract one or more metals to produce a loaded extractant containing the one or more extracted metals. Preferably, the solvent extraction step further comprises the separation of the loaded extractant from the pregnant leach liquor. More preferably, the solvent extraction step further comprises the recovery of the metal from the loaded extractant.

In one form of the present invention, the separate solvent extraction step is adapted to recover copper and nickel from the pregnant leach liquor. Preferably, the pregnant leach liquor is contacted with a copper/nickel extractant to produce a copper and nickel depleted pregnant leach liquor and loaded copper extractant. More preferably, copper and nickel are recovered from the loaded copper extractant by stripping with sulfuric acid. Nickel is selectively stripped with a lower residual acid concentration, preferably in the pH range of 1-4, and copper is stripped with a higher acid concentration, preferably greater than about 50 g/L H₂SO₄. Two stage stripping enables copper and nickel to be separated. Still preferably, copper and nickel are recovered as sulfates.

In one form of the present invention cobalt is precipitated from the nickel and copper depleted raffinate as a sulfide. This is conducted by the addition of a sulfide containing precipitation reagent such as hydrogen sulfide gas or ammonium sulfide to force the precipitation of relatively insoluble cobalt sulfide. The resultant slurry is subjected to a solid liquid separation stage to produce a cobalt product and filtrate containing lithium, ammonium chloride and ammonia.

In one form of the present invention, part of the cobalt depleted filtrate, which contains ammonium chloride and ammonia, is recycled to the leach stage to extract more metal.

In one form of the present invention cobalt is precipitated from the nickel and copper depleted raffinate as a carbonate. This is conducted by the stochiometric addition of carbon dioxide and steam stripping excess ammonia to force the crystallisation of cobalt carbonate. The resultant slurry is subjected to a solid liquid separation stage to produce a cobalt product and filtrate containing lithium and ammonium chloride and ammonia.

In one form of the present invention, part of the cobalt depleted filtrate, which contains ammonium chloride and the recovered ammonia from the steam strip is recycled to the leach stage to extract more metal.

In one form of the present invention, part of the cobalt depleted filtrate, which comprises lithium, ammonia and ammonium chloride is treated to recover the components for recycle and or sale. Ammonia is initially steam stripped and recovered ammonia is directed to the leach to recover more metal. The ammonium chloride, present in the ammonia free liquor, is crystallised by forced evaporation, and subjected to solid liquor separation to produce a solid containing ammonium chloride and liquor containing concentrated lithium chloride. The solids are directed to the leach to recover more metal. The concentrated liquor is subjected to lithium recovery.

In one form of the present invention, the recovery of lithium from the concentrated liquor more specifically comprises the precipitation of a lithium compound. More preferably, the lithium compound is subsequently recovered from the liquor. In one embodiment, the lithium compound is lithium carbonate. Preferably, the concentrated liquor is contacted with ammonium carbonate or ammonia and carbon dioxide to precipitate lithium carbonate. The precipitation slurry is subjected to solid liquor separation to produce a solid containing lithium carbonate and liquor containing ammonium chloride, which is directed to the leach to recover more metal.

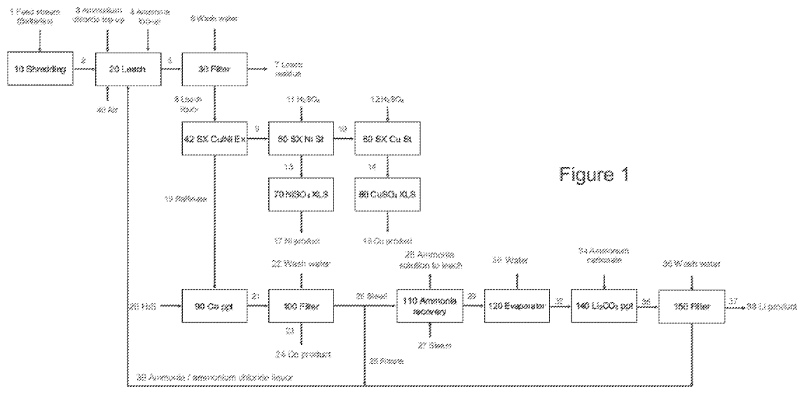

In FIG. 1 there is shown a method in accordance with one embodiment of the present invention, the method being for the recovery of metals from a feed stream containing one or more value metals. The method of FIG. 1 describes the recovery of a nickel product 17 and copper product 18, a cobalt product 24 and a lithium product 38. In this embodiment, a feed stream 1 is subjected to a pre-treatment process, for example shredding 10, to render the feed stream 1 suitable for further processing. The resulting feed stream 2 is then passed to a leach, for example a leaching circuit 20, in which it is contacted with air 40 and a liquor containing ammonia and ammonium chloride, with optional ammonium chloride top-up 3, ammonia top-up 4, ammonia/ammonium chloride liquor 39 recycle, and additionally optional ammonium sulfate 39, to solubilise metal species. The need for top-ups is driven by the concentration of ammonia and ammonium chloride referred to hereinafter.

The leach is conducted at atmospheric pressure and at a temperature of up to about 60° C., for example about 40° C. The concentration of ammonia and ammonium chloride present in the leaching circuit 20 is up to saturation, for example greater than about 5 g/L NH₄Cl, between about 10 g/L and 280 g/L NH₃, for example greater than about 100 g/L NH₃. The residence time of the feed stream 2 in the leaching circuit is in the range of about 1 to 4 hours, for example about 1 to 2 hours.

The resultant leached slurry 5 is subjected to a solid liquid separation step, for example a filter 30, and the solids are washed with water 6, to recover valuable metals from the solids. Undissolved solids 7, or leach residue, are removed and the leach liquor 8 is passed to metal recovery.

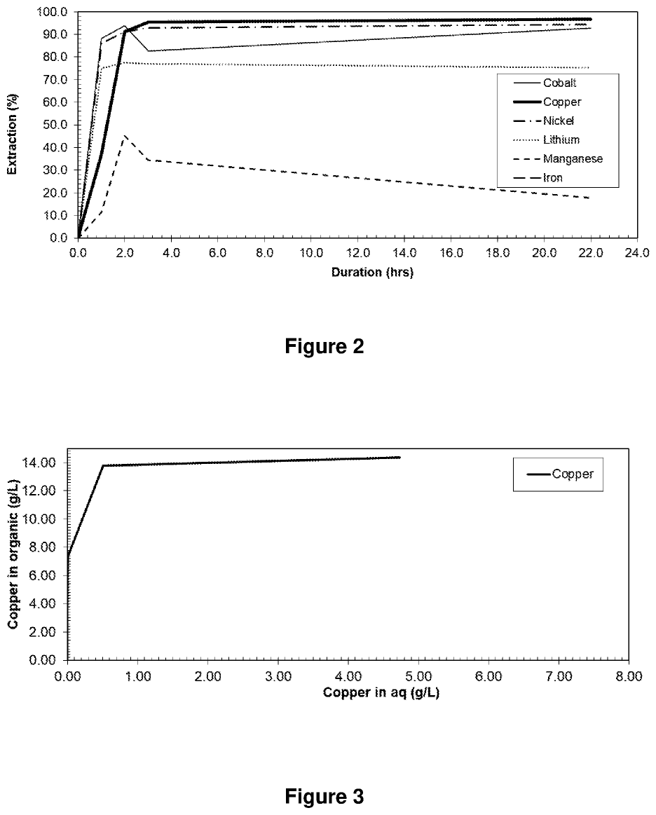

FIG. 2 shows results achieved in the leaching circuit 20 of the present invention over a period of up to 22 hours. Nickel, cobalt and copper extractions of greater than 90% are achieved with a residence time in the leaching circuit 20 of 1 to 2 hours.

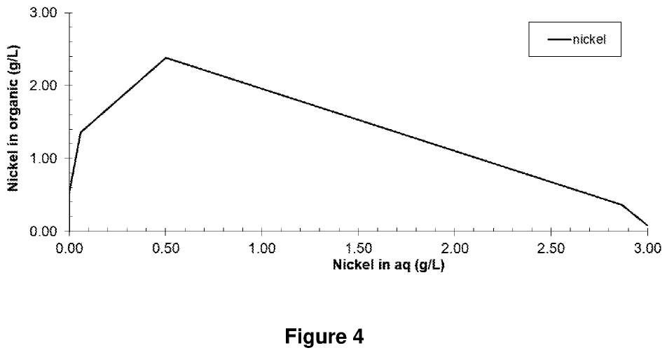

The pregnant leach liquor 8 is directed to a copper and nickel solvent extraction circuit 42 where it is contacted with a copper and nickel extractant, for example an oxime based extractant, including but not limited to ACORGA® M5640 or a LIX® extractant. Copper and nickel are loaded onto the copper extractant and the loaded extractant 9 is separated from the raffinate 19. Copper and nickel solvent extraction isotherms are shown in FIGS. 3 and 4, respectively. FIG. 3 in particular demonstrates the high extraction of copper from the leach liquor 8, whilst FIG. 4 demonstrates the weaker extraction of nickel which is crowded off the organic as more copper is extracted.

The loaded extractant 9 is contacted with dilute sulfuric acid 11 in a nickel strip stage 50 to produce a loaded strip liquor containing nickel 13 and a nickel depleted extractant 10. The specific concentration of the dilute sulfuric acid 11 is sufficient to provide a pH of about 3 in the loaded strip liquor. Further, the dilute sulfuric acid concentration is driven by the desired concentration of nickel in the loaded strip liquor. For example, if 50 g/L Ni is targeted then a sulfuric acid concentration of 83 g/L is required, whereas if 80 g/L Ni is targeted then a sulfuric acid concentration of 132 g/L is required.

The nickel depleted extractant 10 is contacted with dilute sulfuric acid liquor 12 in the copper strip stage 60 to produce a loaded strip liquor 14 containing copper. The stripped organic (not shown) is recycled (not shown) to the extraction circuit 40 to extract more copper and nickel. A nickel product 17 is recovered from the nickel loaded strip liquor 13 in a nickel crystallisation stage 70. A copper product 18 is recovered from the copper loaded strip liquor 14 in a copper crystallisation stage 80.

The copper and nickel depleted raffinate 19 is directed to a cobalt recovery circuit 90 in which a precipitation reagent, for example hydrogen sulfide gas 20, is added to force the precipitation of cobalt sulfide. The resulting slurry 21 is subjected to solid liquid separation, for example by way of a filter 100, and washing with water 22 to produce a cobalt product 24.

Most of the resulting filtrate 25, which contains ammonia and ammonium chloride, is directed to the leach circuit 20 to recover more metal. The remaining filtrate 26 is directed to an ammonia recovery circuit 110, in which steam 27 is used to strip ammonia 28 therefrom. Ammonia 28 recovered thereby is re-used in the process, specifically in the leach 20.

An ammonia free liquor 29 is directed to an evaporator 120 in which water 30 is removed by forced evaporation. The resultant concentrated liquor 32 contains lithium chloride and is directed to the lithium carbonate precipitation stage 140 where it is contacted with ammonium carbonate 34. The resulting slurry 35 is subjected to solid liquor separation, for example in a filter 150, and the solids are washed with water 36 to produce a lithium product 38. A filtrate 39 which contains ammonium chloride is directed to the leach stage 20.

As can be seen with reference to the above description, the method of the present invention is understood to be particularly useful for the recovery of at least a significant portion of all the value metals from spent Li-ion batteries, preferably as high purity sulphates. The process is thought to be particularly robust in that it can accommodate a variety of Li-ion battery chemistries as a single or mixed feed source.

The leach employed in the present invention is selective in that a significant proportion of the contained cobalt, nickel, copper and lithium in the battery is solubilised to the leach liquor of the leach slurry and a significant proportion of the contained iron, manganese and aluminium contained in the battery report to the solid fraction of the leach slurry. The significant proportion of the contained cobalt, nickel, copper and lithium that is solubilised is, for example, greater than about 90% of nickel, copper and cobalt, and greater than about 70% of lithium. The significant proportion of the contained iron, manganese and aluminium contained in the battery that reports to the solid fraction of the leach slurry is, for example, greater than about 99% of aluminium and iron, and greater than about 95% of manganese.

It is envisaged that anions other than chloride may also be present in the leach without departing from the scope of the present invention. For example, sulfate ions may be present as described above, and similarly so may carbonate, bicarbonate and nitrate ions, alone or in combination. For example, as ammonium carbonate is described above as being used for the precipitation of lithium carbonate it is expected that carbonate ions will be present in the leach.

This is achieved by way of an oxidative alkaline leach using ammonia, ammonium ions and air in the presence of chloride ions at atmospheric pressures followed by stage-wise sequential metal recovery using solvent extraction and precipitation techniques. The method of the present invention has been found to be particularly advantageous as there is no sorting of different battery types required.

It is to be understood that the ranges provided herein include the stated range and any value or sub-range within the stated range. For example, a range from about 1 micrometer (μm) to about 2 μm should be interpreted to include not only the explicitly recited limits of from between from about 1 μm to about 2 μm, but also to include individual values, such as about 1.2 μm, about 1.5 μm, about 1.8 μm, etc., and sub-ranges, such as from about 1.1 μm to about 1.9 μm, from about 1.25 μm to about 1.75 μm, etc. It is to be further understood that when “about” and/or “substantially” are/is utilised to describe a value, they are meant to encompass minor variations (up to +/−10%) from the stated value.

The forgoing description is to be considered non-limiting. Modifications and variations such as would be apparent to the skilled addressee are considered to fall within the scope of the present invention.

What is claimed is:

1.-38. (canceled)

39. A method for the recovery of metals from a feed stream containing one or more value metals, the value metals comprising at least lithium, the method comprising:
passing the feed stream to an alkaline leach with an alkaline leach liquor comprising ammonia to form a slurry including a pregnant leach liquor of soluble value metal salts comprising at least lithium ions and a solid residue; and
separating the pregnant leach liquor from the solid residue.

40. The method of claim 39, wherein the method further comprises recovering ammonia, ammonium salt, and lithium from the pregnant leach liquor.

41. The method of claim 40, wherein the value metals further comprise cobalt, copper, and nickel, and wherein the step of recovering lithium from the pregnant leach liquor comprises:
passing the pregnant leach liquor to a solvent extraction step wherein a loaded extractant containing copper and nickel, and a raffinate containing cobalt and lithium are produced; and
recovering cobalt from the raffinate; and
recovering lithium from the cobalt depleted raffinate.

42. The method of claim 39, wherein the alkaline leach is an oxidative alkaline leach, the alkaline leach liquor further comprising ammonium ions, the leach being carried out in the presence of chloride anions, and wherein an oxidant is added during the leach.

43. The method of claim 42, wherein the oxidant comprises: air, hydrogen peroxide, hypochlorite, and a mixture thereof.

44. The method of claim 41, wherein the leach is carried out in the presence of sulfate anions.

45. The method of claim 39, wherein the alkaline leach liquor comprises ammonium chloride and/or ammonium sulfate.

46. The method of claim 39, wherein the leach is: a) conducted at elevated temperature; and/or b) conducted at atmospheric pressure; and/or c) conducted in one or more leach reactors.

47. The method of claim 39, wherein the leach is conducted at atmospheric pressure and at a temperature of: (i) up to about 60° C.; or (ii) about 40° C.

48. The method of claim 39, wherein the alkaline leach liquor further comprises ammonium chloride at a concentration of ammonia and ammonium chloride present in the leach is:
(i) up to saturation;
(ii) greater than about 5 g/L NH₄Cl and between about 10 g/L and 280 g/L NH₃; or
(iii) greater than about 5 g/L NH₄Cl and greater than about 100 g/L NH₃.

49. The method of claim 39, wherein the residence time of the leach is in the range of:
(i) about 1 to 4 hours; or
(ii) about 1 to 2 hours.

50. The method of claim 39, wherein the method further comprises a pre-treatment process prior to the step of passing the feed stream to the alkaline leach, wherein the pre-treatment process comprises one or more size reduction steps comprises: a crushing step, a shredding step, a granulation and a grinding step.

51. The method of claim 39, wherein the feed stream comprises Li-ion batteries.

52. The method of claim 41, wherein the feed stream further comprises aluminum, iron, and manganese, wherein a significant proportion of the cobalt, nickel, copper, and lithium is solubilized to the pregnant leach liquor and a significant proportion of the aluminum, iron, and manganese report to a solid fraction of the leach slurry.

53. The method of claim 52, wherein:
the significant proportion of the cobalt, nickel, copper, and lithium that is solubilized is greater than about 90 wt % nickel, copper and cobalt, and greater than about 70 wt % lithium in the feed; and/or
the significant proportion of the aluminum, iron, and manganese contained that reports to the solid fraction of the leach slurry is greater than about 99% of aluminum and iron, and greater than about 95% of manganese in the feed.

54. The method of claim 41, wherein the solvent extraction step is adapted to recover copper and nickel from the pregnant leach liquor, the pregnant leach liquor being contacted with a copper/nickel extractant to produce a copper and nickel depleted raffinate, and loaded extractant.

55. The method of claim 54, wherein copper and nickel are recovered from the loaded extractant by stripping with sulfuric acid, whereby nickel is selectively stripped with a lower acid concentration, and copper is stripped with a higher acid concentration, enabling copper and nickel to be separated.

56. The method of claim 54, wherein cobalt is precipitated from the copper and nickel depleted raffinate as a sulfide by the addition of a sulfide containing precipitation reagent to form a precipitate of cobalt sulfide.

57. The method of claim 56, wherein a slurry produced by the precipitation of cobalt sulfide is subjected to a solid liquid separation stage to produce a cobalt product and a filtrate containing lithium, ammonium salt, and ammonia.

58. The method of claim 54, wherein cobalt is precipitated from the nickel and copper depleted raffinate as a carbonate.
